(19) United States
(12) Patent Application Publication
(10) Pub. No.: US 2013/0027836 A1
(43) Pub. Date: Jan. 31, 2013

(54) STATIC DISCHARGE ISOLATION DEVICE AND COMPUTER CASE ASSEMBLY WITH SAME

(71) Applicants: JUN-WEI WANG, Shenzhen City (CN); QIANG CHAI, Shenzhen City (CN)

(72) Inventors: JUN-WEI WANG, Shenzhen City (CN); QIANG CHAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/310,715

(22) Filed: Dec. 3, 2011

(30) Foreign Application Priority Data
Jul. 29, 2011 (CN) 201110215730.X

(51) Int. Cl. H05F 3/00

(52) U.S. Cl. 361/220

(57) ABSTRACT

Provided is a static discharge isolation device for mounting on a case of a computer. The case includes a sidewall with an array of exposed interfaces. The static discharge isolation device composed of a dielectric. The static discharge isolation device includes a main body. The main body defines a number of cavities. The number, size, shape, and arrangement of the cavities are such to ensure each interface of the computer being closely surrounded by a corresponding cavity.

### BACKGROUND

1. Technical Field

The disclosure relates to isolation devices and, particularly, to a static discharge isolation device to electrically isolate a component of a computer to be tested.

2. Description of Related Art

Electronic devices such as computers may include many different exposed interfaces, such as, USB interfaces or cable interfaces (RJ 45 interface). An Electrostatic Discharge (ESD) test may be performed on the interfaces. Such test is performed by placing a static discharging device in contact with the interface and releasing a static discharge. In some cases, the discharge may be misapplied to the computer case and when the discharge is too strong or not grounded quickly enough, it may penetrate to sensitive components inside the computers and cause damage.

What is needed, therefore, is a static discharge isolation device to overcome the above-described problem.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a partial view of a computer case assembly with network interfaces and an isolation bracket before assembly, according to an embodiment.

FIG. 2 is an assembled view of FIG. 1.

FIG. 3 is similar to FIG. 2, but shown during an electrostatic discharge test.

### DETAILED DESCRIPTION

Embodiments of the disclosure will now be described in detail below, with reference to the accompanying drawings.

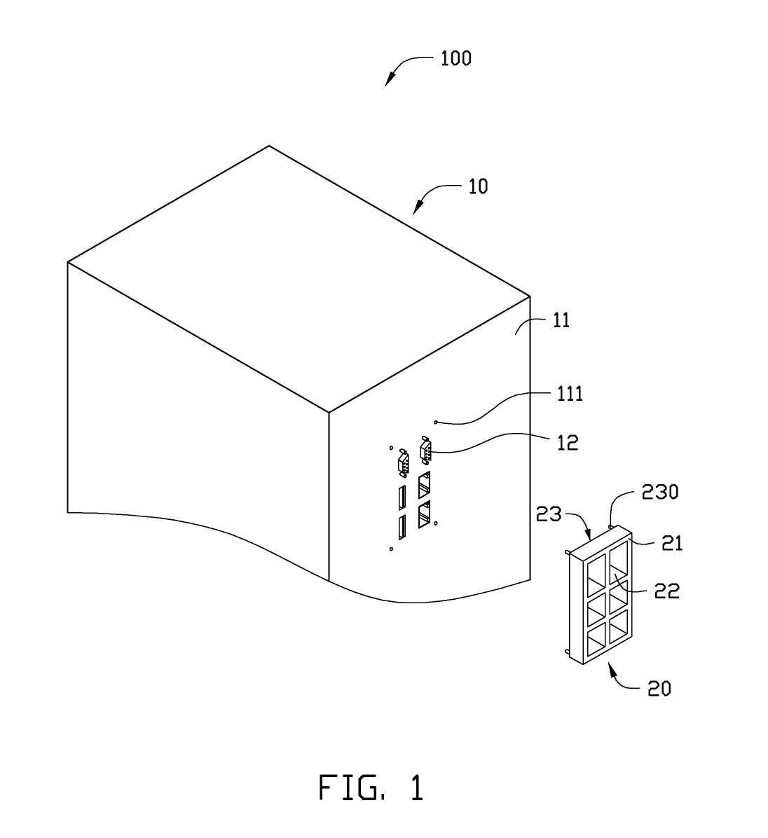

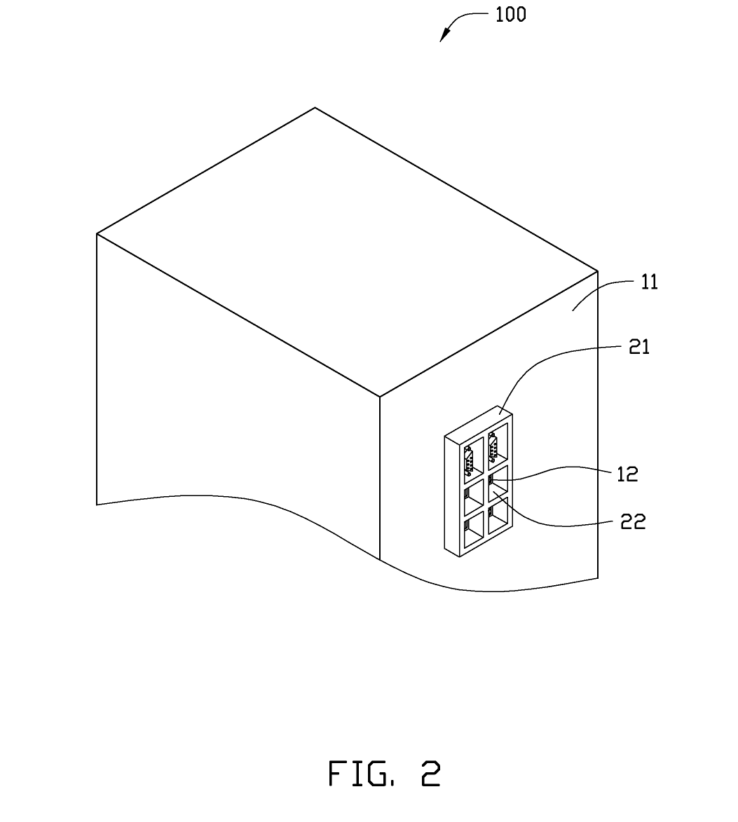

Referring to FIGS. 1-2, a computer case assembly 100, according to an embodiment, includes a case 10 and a static discharge isolation device 20 for mounting on the case 10.

In the embodiment, the case 10 includes a sidewall 11 with an array of six exposed interfaces 12. The sidewall 11 also includes four first engaging portions 111 surrounding the interfaces 12. In the embodiment, the first engaging portions 111 are through holes defined in the sidewall 11.

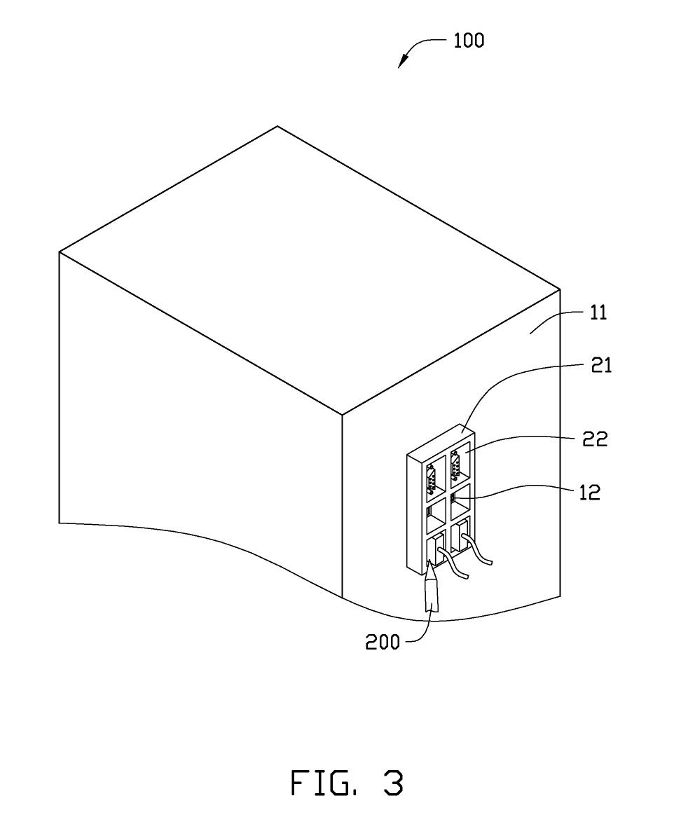

The static discharge isolation device 20 includes a main body 21, which defines a number of cavities 22. The number, size, shape, and arrangement of the cavities 22 are such to ensure each interface 12 to be tested being closely surrounded by a corresponding cavity 22, so that it is still easy for a technician to contact a discharge probe 200 (Please seeing FIG. 3) on each interface 12 but prevent accidental contact with surrounding surface of the case 10.

The static discharge isolation device 20 is composed of a dielectric, such as plastic. The static discharge isolation 20 includes a connecting surface 23. Four second engaging portions 230 are formed on the connecting surface 23, and are configured to engage in the first engaging portions 111. In the embodiment, the second engaging portions 230 are protrusions perpendicularly protruding from the connecting surface 23.

In alternative embodiments, the position of the first engaging portions 111 and the second engaging portions 230 can be interchanged, that is, each first engaging portion 111 is a protrusion, while each second engaging portion 230 is a through hole.

In assembly, the static discharge isolation 20 is mounted onto the sidewall 11 of the case 10 by the four second engaging portions 230 being fittingly engaged in the first engaging portions 111. Alternately, the engaging portions other connections means and can even be replaced with adhesive, or accomplished by welding (e.g., plastic welding).

During ESD testing, referring to FIG. 3, the discharge probe 200 can easily be contacted with each interface 12 without accidentally touching surrounding surface of the sidewall 11, thus protecting sensitive components inside the case 10.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope of the appended claims.

What is claimed is:

1. A static discharge isolation device for mounting on a case of a computer, the case comprising a sidewall with an array of exposed interfaces, the static discharge isolation device composed of a dielectric, and comprising:
a main body defining a plurality of cavities, the number, size, shape, and arrangement of the cavities being such to ensure each interface of the computer being closely surrounded by a corresponding cavity.

2. The static discharge isolation device of claim 1, wherein the dielectric is plastic.

3. A computer case assembly, comprising:
a case comprising a sidewall with an array of exposed interfaces; and
a static discharge isolation device composed of a dielectric and mounted on the sidewall, the static discharge isolation device comprising:
a main body defining a plurality of cavities, each interface being received and closely surrounded by a corresponding cavity.

4. The computer case assembly of claim 3, wherein the sidewall comprises four first engaging portions surrounding the interfaces, the static discharge isolation comprises a connecting surface and four second engaging portions arranged on the connecting surface, the second engaging portions engage in the first engaging portions to mount the static discharge isolation on the sidewall of the case.

5. The computer case assembly of claim 4, wherein the first engaging portions are through holes defined in the sidewall, the second engaging portions are protrusions perpendicularly protruding from the connecting surface.

6. The computer case assembly of claim 4, wherein the first engaging portions are protrusions, and the second engaging portions are through holes.

7. The computer case assembly of claim 3, wherein the dielectric is plastic.
